(19) United States
(12) Patent Application Publication
(10) Pub. No.: US 2026/0259989 A1
(43) Pub. Date: Sep. 3, 2026

(54) Methods and Systems for IT Security Tests

(71) Applicant: Siemens Aktiengesellschaft, München (DE)

(72) Inventors: Klaus Lukas, München (DE); Reinhard Riedmüller, München (DE); Thomas Pröll, München (DE)

(73) Assignee: Siemens Aktiengesellschaft, München (DE)

(21) Appl. No.: 18/841,794

(22) PCT Filed: Feb. 13, 2023
(86) PCT No.: PCT/EP2023/053458

§ 371 Date: Aug. 27, 2024

(30) Foreign Application Priority Data
Feb. 28, 2022 (DE) 10 2022 202 020.0
Apr. 19, 2022 (EP) 22168793.2

(51) Int. Cl. G06F 21/57; G06F 21/56

(52) U.S. Cl. CPC G06F 21/577; G06F 21/567; G06F 2221/034

(57) ABSTRACT

Various embodiments of the teachings herein include a method for a security test of a device with a data connection. An example includes: carrying out an IT security test of the device; acquiring a data feedback of the device using the data connection throughout the IT security test; acquiring a device status of the device optically and/or acoustically; and evaluating the data feedback in light of the acquired device status.

### CROSS-REFERENCE TO RELATED APPLICATIONS

This application is a U.S. National Stage Application of International Application No. PCT/EP2023/053458 filed Feb. 13, 2023, which designates the United States of America, and claims priority to EP Patent Application No. 22168793.2 filed Apr. 19, 2022 and DE Application No. 10 2022 202 020.0 filed Feb. 28, 2022, the contents of which are hereby incorporated by reference in their entirety.

### TECHNICAL FIELD

The present disclosure relates to information technology (IT) systems. Various embodiments of the teachings herein include methods and/or systems for IT security tests.

### BACKGROUND

Subjecting devices to IT security tests by means of test platforms is known. The devices are normally connected for this purpose by means of a data connection to a test platform to carry out the IT security test. While the device normally remains addressable via the data connection, it can occur in specific cases, however, that the device is no longer addressable and does not react in the usual manner. In these cases, IT security tests can have a lower reliability.

### SUMMARY

The teachings of the present disclosure include methods for carrying out an IT security test by means of which IT security tests can be carried out by devices in an improved, in particular more reliable manner. Some embodiments include systems for carrying out an IT security test by means of which the methods for carrying out an IT security test described herein can be carried out. For example, some embodiments include a method for carrying out an IT security test of a device (DEV) by means of a data connection (KOM), in particular a network connection, in which the IT security test of the device (DEV) is carried out, a data feedback of the device is acquired by means of the data connection (KOM) as the IT security test is carried out, a device status of the device (DEV) is additionally optically and/or acoustically acquired, and the data feedback is evaluated in consideration of the acquired device status.

In some embodiments, acquisition is performed optically and/or acoustically by means of at least one acquisition means (MIK, VID), in particular by means of at least one camera (VID) and/or by means of at least one microphone (MIK).

In some embodiments, the data feedback comprises feedback data and/or comprises the information as to whether feedback data were received or whether no or fewer feedback data were received than expected.

In some embodiments, the acquired device status is used to derive an item of security information from the data feedback in dependence on the device status.

In some embodiments, the acquired device status is used to operate the device (DEV) in dependence on the device status, in particular to reset the device (DEV).

In some embodiments, the acquired device status is used in order to put the device (DEV) in a safe operating mode and/or to subject it to a software update and/or to take it out of operation and/or switch it off or to put it in an idle status.

In some embodiments, the device status is acquired in that an acoustic signal of the device (DEV), in particular an alarm signal of the device (DEV) and/or an optical signal of the device (DEV), in particular a display of the device (DEV), is acquired.

As another example, some embodiments include a system for carrying out an IT security test of a device (DEV) for carrying out a method as claimed described herein, the system including: a communication interface (KOM) for a data connection to the device (DEV), a test unit for carrying out the IT security test, which is designed to acquire a data feedback of the device (DEV), and at least one acquisition means (MIK, VID) for the optical and/or acoustic acquisition of the device status, having an evaluation unit (DET), which is designed to evaluate the data feedback in consideration of the acquired device status.

In some embodiments, the system is designed to carry out an IT security test of a device (DEV) having a graphic and/or acoustic user interface, wherein the at least one acquisition means is designed to acquire the user interface.

In some embodiments, the at least one acquisition means has at least one camera (VID) and/or at least one microphone (MIK).

In some embodiments, there is at least one actuator designed to operate the device (DEV) in dependence on the device status.

In some embodiments, the system is designed to carry out an IT security test of a device (DEV) having at least one user interface, wherein the actuator is configured to operate the at least one user interface of the device (DEV).

As another example, some embodiments include a manufacturing facility and/or maintenance facility and/or logistics facility having a system as described herein.

### BRIEF DESCRIPTION OF THE DRAWINGS

The teachings herein are explained in more detail hereinafter on the basis of an exemplary embodiment illustrated in the drawing. The single FIGURE of the drawing shows a sequence of an example method incorporating teachings of the present disclosure for carrying out an IT security test of a device in a flow chart.

### DETAILED DESCRIPTION

In some embodiments, there is a method for carrying out an IT security test of a device by means of a data connection, in particular a network connection. the IT security test of the devices is carried out and data feedback of the device is acquired by means of the data connection as the IT security test is carried out and a device status of the device is additionally optically and/or acoustically acquired and the data feedback is evaluated in consideration of the acquired device status. By means of the optical and/or acoustic acquisition of the device status of the device, in addition to the data connection, optically and/or acoustically acquired items of information about the device status are available, so that in those cases in which data feedback is absent or data feedback occurs differently than expected, the device status can be used. By means of the additionally used device status, it can be concluded even if data feedback is absent whether the device is still ready for use or whether the device is in a disturbed functional status. If the device is in a disturbed functional status during the IT security test, the information about the presence of the disturbed functional status of the device can be incorporated in the IT security test as an additional test result of the IT security test in the evaluation of the IT security test.

In some embodiments, the acquisition is performed optically and/or acoustically by means of at least one acquisition means, in particular by means of at least one camera and/or by means of at least one microphone. One or more user interfaces of the device may be acquired by means of the acquisition means. The device status of the device can thus easily be inferred by means of an acquisition of the user interfaces of the device. In some embodiments, a graphic user interface or acoustic signals for users can be acquired in the method according to the invention. Communications, in particular warning signals or warning messages or alarm messages can be displayed by means of graphic user interfaces, which can easily be acquired by means of the acquisition means. Acoustic warning signals or warning messages, for example alarm tones such as alarm buzzers in particular, can also easily be acquired. Such graphic or acoustic warning signals permit a reliable inference about an unintended device status of the device.

The data feedback comprises feedback data and/or the information as to whether feedback data were received or whether no or fewer feedback data were received than expected. A data feedback can thus comprise, on the one hand, feedback data of the device which the device outputs as a response to test data forming input data of the device. Moreover, a data feedback can also mean the absence of feedback data, in particular in those situations in which feedback data are expected. The absence of feedback data can also comprise an item of feedback information of the device in such situations.

In some embodiments, the acquired device status is used to derive an item of security information from the data feedback in dependence on the device status. An item of security information can be obtained significantly more reliably from the combination of the device status with the data feedback than from the data feedback alone. In particular, a device status can be related to a simultaneous or chronologically preceding data feedback and an influence or a correlation of the data feedback with the device status can thus be taken into consideration.

In some embodiments, the acquired device status is expediently used to operate the device in dependence on the device status, in particular to reset the device. If a disturbed device status of the device is concluded on the basis of the acquired device status, the device can be reset by means of this refinement of the method according to the invention. An actuator may be expediently used for this purpose, which initiates a reset procedure, in particular by means of an operation of a reset button or by means of a reset panel of a touchscreen or by means of an interruption of an electrical supply or by means of an effectuation of an electrical short circuit.

In some embodiments, the acquired device status is used to put the device into a safe operating mode and/or to subject it to a software update and/or to take it out of operation and/or switch it off or to put it into an idle status.

The device status is suitably acquired in that an acoustic signal of the device, in particular an alarm signal of the device and/or an optical signal of the device, in particular a display of the device, is acquired. Optical signals and/or acoustic signals can advantageously be used to acquire the device status in a manner that is easy to classify and can be related to a device status.

In some embodiments, the device status forms or comprises an error status of the device, wherein the device status is acquired on the basis of an error message, in particular an optical messaging signal, preferably a messaging window, and/or an acoustic signal, of the device and/or an operating system of the device and/or software of the device.

As an example, some embodiments of the teachings herein include a system for carrying out an IT security test of a device for carrying out one or more of the methods as described herein has a communication interface for a data connection to the device and has a test unit for carrying out the IT security test, which is designed to acquire a data feedback of the device, and has at least one acquisition means for the optical and/or acoustic acquisition of the device status and an evaluation unit, which is designed to evaluate the data feedback in consideration of the acquired device status. The system is designed to execute one or more of the methods as described above and accordingly has the advantages already explained for the methods.

The system is designed to carry out an IT security test of a device having a graphic and/or optical and/or acoustic user interface, wherein the at least one acquisition means is designed to acquire the user interface. In particular optical and/or acoustic user interfaces can easily be acquired using acquisition means designed for optical and/or acoustic acquisition.

The at least one acquisition means has at least one camera and/or at least one microphone.

The system has at least one actuator designed to operate the device in dependence on the device status. Such an actuator may be designed to operate a reset button or a reset panel on a touchscreen.

The system is designed to carry out an IT security test of a device having at least one user interface, wherein the actuator is configured to operate the at least one user interface of the device.

The manufacturing facility and/or maintenance facility and/or logistics facility has a system as described herein. The manufacturing facility and/or maintenance facility and/or logistics facility moreover expediently comprises the device, which may be a control device and/or manufacturing device and/or maintenance device and/or logistics device, expediently a manufacturing tool and/or manufacturing robot and/or maintenance tool and/or maintenance robot and/or a logistics tool and/or a logistics robot and/or logistics vehicle.

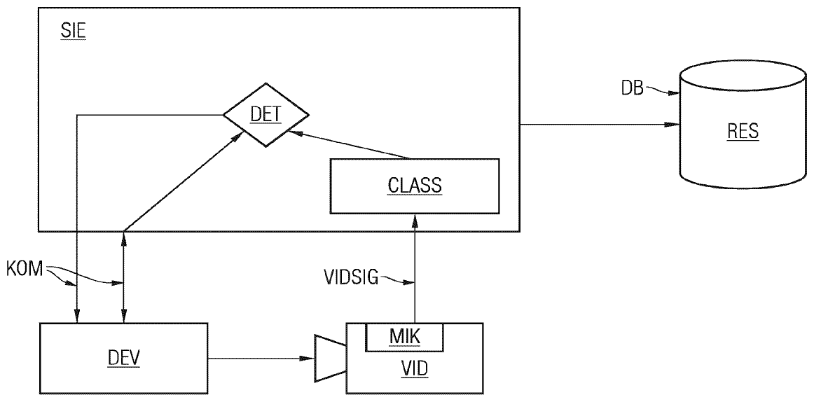

The flow chart shown in FIG. 1 shows a sequence of an IT security test of a device DEV in the form of a manufacturing device, such as a program-controlled milling cutter, of a manufacturing facility MAN networked by means of an IoT network. In some embodiments, the device can also be a logistics device, such as a mobile warehouse robot, of a logistics facility networked by means of an IoT network, or a maintenance device, such as a maintenance robot, of a maintenance facility networked by means of an IoT network.

The device DEV has, on the one hand, a communication interface KOM for the data connection by means of which the device DEV can be program-controlled. The device DEV additionally has a user interface USE, by means of which a user can identify an operating mode, for example a productive mode here, in which the device DEV is actuated by programming to manufacture a product by means of the communication interface KOM, a maintenance mode, in which a software update of the device DEV can take place, and an idle status, in which the device is not addressable via the communication interface KOM.

By means of the communication interface KOM, the device DEV is fed with an array of fuzzing input data during an IT security test of the device DEV from a test platform SIE and a data feedback of the device DEV is observed. In a secure normal operation, the device DEV, by means of the communication interface KOM, outputs confirmation data for the acceptance of the input data and transmits documentation data at regular time intervals on the operation of the device DEV. The data feedback is therefore composed in the normal status of the device DEV of feedback data, comprising these confirmation data and documentation data.

The test platform SIE receives this data feedback and evaluates this data feedback. The data feedback is related to the fuzzing input data transmitted to the device and deviations from the provided normal operation can be checked for IT security gaps by means of the test platform SIE.

However, if the fuzzing input data shift the device DEV from the normal operation into a disturbed device status, the device DEV thus stops its data feedback in the exemplary embodiment shown. Therefore, feedback data are no longer received by the test platform SIE by means of the communication interface KOM. The data feedback is therefore characterized by absent feedback data.

However, the test platform SIE does not solely have a communication interface KOM, but rather the test platform SIE additionally has acquisition means in the form of a video camera VID and a microphone MIK.

The user interface USE of the device DEV is filmed by means of the video camera VID. If the device DEV stops its data feedback, the image recorded by the video camera VID of the user interface USE of the device DEV is evaluated. The user interface can have a display in which an error message in the form of a messaging window of an operating system of the device DEV appears. The video camera VID transmits the image of the display with the messaging window by means of a video signal connection VIDSIG to the test platform SIE.

A classification unit CLASS of the test platform SIE is trained to evaluate and classify the images of the display having the messaging window. The messaging window can thus contain an error message which indicates an error status of the device DEV, for example, an error message “Device not responding. Further operation requires restart.” The classification device CLASS of the test platform SIE is trained to identify the messaging window and acquire the text content. For this purpose, the classification device has a neural network, which has experienced a corresponding training in a way known per se.

The classification unit CLASS now transmits the image signals classified on the basis of the acquired text content, i.e. a class assigned to the acquired image signals, to a status determination unit DET, which assigns the acquired text content of the messaging window to a device status of the device DEV.

Analogously to the images of the video camera, the microphone MIK records sound signals of the user interface USE of the device DEV. The user interface USE of the device DEV outputs a warning tone when the device DEV stops its data feedback. The microphone MIK also transmits the sound signal via the video signal connection VIDSIG to the test platform SIE. The classification device CLASS additionally also classifies the sound signals and transmits the classification of the sound signal, i.e. a class assigned to the acquired sound signals, to the status determination device DET. The status determination device DET has an assignment rule ready in an internal memory, which assigns the classified sound signals and image signals, thus the classes of the sound signals and the image signals, to an internal device status of the device DEV. The data feedback is analyzed and the fuzzing input data are analyzed on the basis of the assigned device status. It can, for example, be concluded in a way known per se by means of the test platform SIE which fuzzing input data result in the device status determined by means of the status determination device DET and which data feedback typically directly precedes in each case such a device status with absent feedback data. These test results RES, which were concluded by means of the test platform SIE, are transmitted to a result database DB, which stores and documents the test results RES.

In addition, the device status determined in this way is used to continue the test. The fuzzing input data which have resulted in the disturbed device status can thus be modified, for example, so that in further test runs such a disturbed device status can be avoided. In further exemplary embodiments, the fuzzing input data can also be varied in such a way that it can be abstracted which type of fuzzing input data result in a disturbed device status.

Furthermore, in an exemplary embodiment which is not shown separately, the test platform SIE can be signal-connected to an actuator in the form of a robot finger, which can press a reset button of the user interface USE of the device DEV. In some embodiments, the user interface can have a touchscreen and the actuator can operate a reset panel of the touchscreen. In some embodiments, the actuator can be a circuit breaker, which breaks a circuit of the device DEV and/or can be a short circuit element which induces a short-circuit of the device DEV. The test platform SIE can thus, in those cases in which a disturbed device status with absent feedback data occurs, transfer a reset signal to the robot finger, which thereupon presses the reset button of the user interface USE. The device DEV can thus be restarted and the IT security test can be continued using the test platform SIE.

What is claimed is:

1. A method for security test of a device with a data connection the method comprising:
carrying out an IT security test of the device;
acquiring a data feedback of the device using the data connection throughout the IT security test;
acquiring a device status of the device optically and/or acoustically; and
evaluating the data feedback in light of the acquired device status.

2. The method as claimed in claim 1, wherein acquiring a device status includes using a camera and/or a microphone.

3. The method as claimed in claim 1, wherein the data feedback comprises feedback data, whether feedback data were received, and/or whether fewer feedback data were received than expected.

4. The method as claimed in claim 3, further comprising using the acquired device status to derive an item of security information from the data feedback based on the device status.

5. The method as claimed in claim 4, further comprising using the acquired device status to operate the device based on the device status.

6. The method as claimed in claim 1, further comprising using the acquired device status to put the device in a safe operating mode, subject it to a software update, take it out of operation, switch it off, and/or put it in an idle status.

7. The method as claimed in claim 1, wherein acquiring the device status includes receiving an acoustic signal of the device.

8. A system for carrying out a security test of a device, the system comprising:
a communication interface for a data connection to the device;
a test unit for carrying out an information technology (IT) security test to acquire a data feedback from the device;
an acquisition means for optical and/or acoustic acquisition of a status of the device; and
an evaluation unit to evaluate the data feedback in consideration of the acquired device status.

9. The system as claimed in claim 8, wherein:
the device comprising a graphic and/or acoustic user interface; and
the acquisition means monitors the user interface.

10. The system as claimed in claim 8, wherein the acquisition means comprises a camera and/or a microphone.

11. The system as claimed in claim 8, further comprising an actuator to operate the device based on the device status.

12. The system as claimed in claim 11, wherein:
the device includes a user interface; and
the actuator operates the user interface.

13. (canceled)
